(19) United States
(12) Patent Application Publication
(10) Pub. No.: US 2012/0260033 A1
(43) Pub. Date: Oct. 11, 2012

(54) COMPUTING DEVICE, STORAGE MEDIUM AND METHOD FOR PROCESS A TEST RESULT REPORT USING THE COMPUTING DEVICE

(75) Inventor: YI-TSANG CHEN, Tu-Cheng (TW)

(73) Assignee: HON HAI PRECISION INDUSTRY CO., LTD., Tu-Cheng (TW)

(21) Appl. No.: 13/337,120

(22) Filed: Dec. 25, 2011

(30) Foreign Application Priority Data
Apr. 6, 2011 (TW) 100111722

(51) Int. Cl. G06F 12/08; G06F 17/30

(52) U.S. Cl. 711/112; 707/754; 711/E12.019; 707/E17.059

(57) ABSTRACT

In a method for processing test result reports using a computing device, the test result report is read from an original storage section of a database of the computing device. The method generates a classified report by classifying the test result report into a classification storage section of the database according to the file name of the test result report. The method further generates a filtrated reports by filtrating specific fields in the classified report according to predetermined important fields, and stores the filtrated report into a filtration storage section of the database. The method generates a desired result report by adding a parameter field into the filtrated report to store test parameters of the test result report, and stores the desired result report in a result storage section of the database.

### BACKGROUND

1. Technical Field

Embodiments of the present disclosure relate to data report processing systems and methods, and more particularly to a computing device, storage medium and method for processing a test result report using the computing device.

2. Description of Related Art

In a process of testing performance of a storage system, it is very important to manage and optimize a test result report. Management of the test result report may be processed manually to acquire an optimized report, such as, classifying the test result report, filtrating desired fields, for example. Due to a large amount of data in the test result report, it may be inefficient and time-consuming for users to manage and optimize the test result report.

### BRIEF DESCRIPTION OF THE DRAWINGS

FIG. 1 is a block diagram of one embodiment of a computing device including a processing system.

FIG. 2 is a block diagram of function modules of the processing system included in the computing device of FIG. 1.

FIG. 3 is a flowchart of one embodiment of a system for processing a test result report using the computing device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word module, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

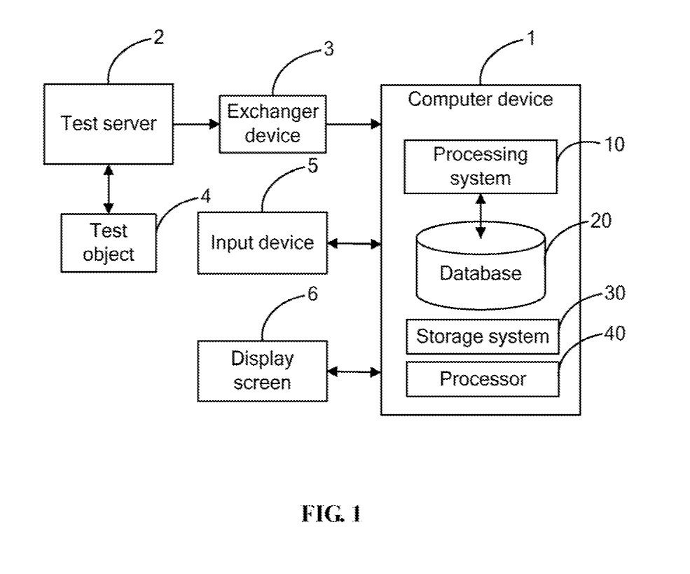

FIG. 1 is a block diagram of one embodiment of a computing device 1 including a processing system 10. The computing device 1 includes a database 20, and communicates with a test server 2 through an exchanger device 3 (e.g., a Gigabit Ethernet Switch). The test server 2 may set test parameters through predetermined Input/Output (IO) test software, and test performance of a test object 4 to generate a test result report according to the test parameters. In one embodiment, the test object 4 may be a storage system, and the test result report may be a spreadsheet format. The processing system 10 can automatically process the test result report to generate a desired result report, and manages data of the desired result report conveniently.

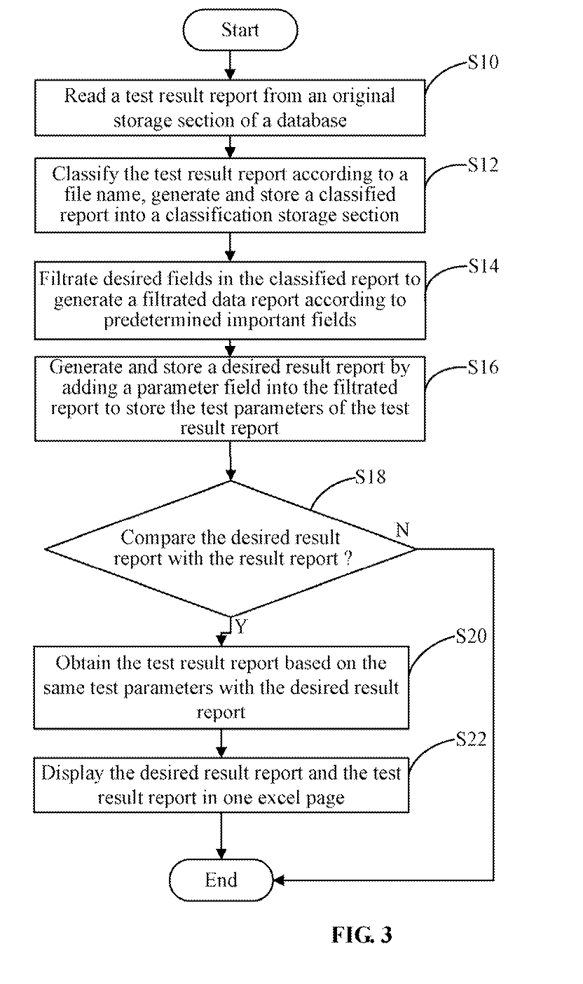

The test parameters may include test items, reference values, and Redundant Array of Independent Disk (RAID) levels. The test result report may include a plurality of fields, such as, a field of Mbps about Data Transfer Rate, an Input/Output Operations Per Second (IOPS) filed, a field of I/O response time about the test object 4, for example. In one embodiment, the database 20 may include an original storage section, a classification storage section, a filtration storage section and a result storage section. Each of the above-mentioned storage sections is used to store and manage the test result report of the test object 4. Details will be described with FIG. 3.

The computing device 1 may connect to an input device 5 and a display screen 6. Users may input the test parameters through the input device 5. The input device 5 may be a mouse, or a keyboard, for example. The display screen 6 may display the test result reports of the computing device 1. The computing device 1 further includes a storage system 30 and at least one processor 40. The storage system 30 stores data of the test result report. The at least one processor 40 executes one or more computerized codes and other applications of the computing device 1, to provide functions of the processing system 10.

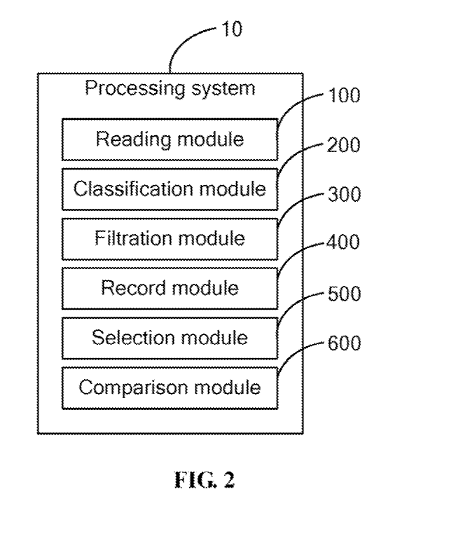

FIG. 2 is a block diagram of function modules of the processing system 10 included in the computing device 1 of FIG. 1. In the embodiment, the processing system 10 may include a reading module 100, a classification module 200, a filtration module 300, a recording module 400, a selection module 500 and a comparison module 600. The modules 100, 200, 300, 400, 500, and 600 comprise computerized codes in the form of one or more programs that are stored in the storage system 30 of the computing device 1. The computerized code includes instructions that are executed by the at least one processor 40 of the computing device 1 to provide functions for the modules. Details of these operations follow.

FIG. 3 is a flowchart of one embodiment of a method for processing a test result report using the computing device 1 of FIG. 1. In the embodiment, the test result report is generated when the test server 2 tests performance of the test object 4, and is sent to the computing device 1 through the exchanger device 3. Depending on the embodiment, additional blocks may be added, others deleted, and the ordering of the blocks may be changed.

In block S10, the reading module 100 reads the test result report from the original storage section of the database 20 when the test server 2 transmits the test result report to the computing device 1. In one embodiment, the test result report is named according to the RAID levels of the test parameters. The RAID levels may be set RAID 0, RAID 1, RAID 5, or RAID 6. Therefore, the test result report may be named to be R0_xxx, R1_xxx, R5_xxx, or R6_xxx according to the RAID levels, where “xxx” is randomly named according to the user preference.

In block S12, the classification module 200 generates a classified report by classifying the test result report into the classification storage section according to the file name of the test result report. In one embodiment, according to the RAID levels, the classification storage section may be divided into 4 parts, such as parts of R0 type, R1 type, R5 type and R6 type, to store the test result report. If the file name of the test result report is “R1_xxx”, the classification module 200 may classify the test result report into the part of R1 type.

In block S14, the filtration module 300 generates a filtrated report by filtrating desired fields of the classified report according to predetermined important fields, and stores the filtrated report into the filtration storage section. In one embodiment, the desired fields may be preset as an Mbps field and an IOPS filed, and are predetermined as the important fields to be filtrated.

In block S16, the recording module 400 generates a desired result report by adding a parameter field into the filtrated report to store the test parameters of the test result report input from the input device 5, and stores the desired result report in the result storage section.

In block S18, the selection module 500 prompts the user of the computing device 1 whether to compare the desired result report with the test result report based on the same test parameters on the display screen 6. In one embodiment, the selection module 500 may display a message of “compare the desired result with an original test result report or not”. If the user selects to compare the desired result with the test result report, block S20 is implemented. If the user does not select to compare the desired result with the test result report, the procedure ends.

In block S20, the selection module 500 obtains the test result report based on the same test parameters of the desired result report from the original storage section.

In block S22, the comparison module 600 opens the desired result report and the test result report, and displays the two result reports on one page on the display screen 6. Users may compare differences between the two result reports conveniently.

All of the processes described above may be embodied in, and fully automated via, functional code modules executed by one or more general purpose processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

The described embodiments are merely possible examples of implementations, and have been set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A method for processing test result reports using a computing device, the method comprising:
reading a test result report from an original storage section of a database of the computing device;
generating a classified report by classifying the test result report into a classification storage section of the database according to a file name of the test result report;
generating a filtrated report by filtrating desired fields in the classified report according to predetermined important fields, and storing the filtrated report into a filtration storage section of the database;
generating a desired result report by adding a parameter field into the filtrated report for storing test parameters of the test result report, and storing the desired result report in a result storage section of the database.

2. The method as claimed in claim 1, further comprising:
displaying a message on a display screen of the computing device, the messaging prompting a user to compare the desired result report with the test result report based on the same test parameters;
obtaining the test result report based on the same test parameters from the original storage section, if the desired result report is selected to compare with the test result report;
displaying the desired result report and the test result report on one page on the display screen.

3. The method as claimed in claim 1, wherein the test result report stored in the original storage section is named according to Redundant Array of Independent Disk (RAID) levels of the test parameters.

4. The method as claimed in claim 1, wherein the test result report is classified to store into a classification storage section according to the RAID levels of the test result report.

5. The method as claimed in claim 1, wherein the test result report is a spreadsheet format.

6. A non-transitory storage medium storing a set of instructions, the set of instructions capable of being executed by a computing device, causes the computing device to perform a method for processing test result reports, the method comprising:
reading a test result report from an original storage section of a database of the computing device;
generating a classified report by classifying the test result report into a classification storage section of the database according to a file name of the test result report;
generating a filtrated report by filtrating desired fields in the classified report according to predetermined important fields, and storing the filtrated report into a filtration storage section of the database;
generating a desired result report by adding a parameter field into the filtrated report for storing test parameters of the test result report, and storing the desired result report in a result storage section of the database.

7. The storage medium as claimed in claim 6, wherein the method further comprise:
displaying a message on a display screen of the computing device, the messaging prompting a user to compare the desired result report with the test result report based on the same testing parameters;
obtaining the test result report based on the same test parameters from the original storage section, if the desired result report is selected to compare with the test result report;
displaying the desired result report and the test result report on one page on the display screen.

8. The storage medium as claimed in claim 6, wherein the test result report stored in the original storage section is named according to Redundant Array of Independent Disk (RAID) levels of the test parameters.

9. The storage medium as claimed in claim 6, wherein the test result report is classified to store into a classification storage section according to the RAID levels of the test result report.

10. The storage medium as claimed in claim 6, wherein the test result report is a spreadsheet format.

11. A computing device, comprising:
a display;
a database;
a storage system and at least one processor; and
one or more programs that are stored in the storage system and executed by the at least one processor, the one or more programs comprising:
a reading module that reads a test result report from an original storage section of the database;
a classification module that generates a classified report by classifying the test result report into a classification storage section of the database according to a file name of the test result report;
a filtration module that generates a filtrated report by filtrating desired fields in the classified report according to predetermined important fields, and stores the filtrated report into a filtration storage section of the database;
a recording module that generates a desired result report by adding a parameter field into the filtrated report for storing test parameters of the test result report, and stores the desired result report in a result storage section of the database.

12. The computing device as claimed in claim 11, wherein the one or more programs further comprises:
a selection module that displays a message on a display screen of the computing device, the messaging prompting a user to compare the desired result report with the test result report based on the same testing parameters;
the selection module further that obtains the test result report based on the same test parameters from the original storage section, if the desired result report is selected to compare with the test result report;
a comparison module that displays the desired result report and the test result report on one page on the display screen.

13. The computing device as claimed in claim 11, wherein the test result report stored in the original storage section is named according to Redundant Array of Independent Disk (RAID) levels of the test parameters.

14. The computing device as claimed in claim 11, wherein the test result report is classified to store into a classification storage section according to the RAID levels of the test result report.

15. The computing device as claimed in claim 11, wherein the test result report is a spreadsheet format.
